(19) United States
(12) Patent Application Publication
(10) Pub. No.: US 2026/0012066 A1
(43) Pub. Date: Jan. 8, 2026

(54) STEPPING MOTOR

(71) Applicant: AAC Microtech (Changzhou) Co., Ltd., Changzhou City (CN)

(72) Inventor: Zhuming Chu, Changzhou (CN)

(21) Appl. No.: 19/001,510

(22) Filed: Dec. 25, 2024

Related U.S. Application Data
(63) Continuation of application No. PCT/CN2024/103181, filed on Jul. 2, 2024.

(51) Int. Cl. H02K 37/00; H02K 1/14; H02K 7/08

(52) U.S. Cl. CPC H02K 37/00; H02K 1/145; H02K 7/083

(57) ABSTRACT

The present invention relates to the technical field of electric motors, in particular to a stepping motor. The stepping motor includes a first cover plate, a second cover plate, a stator assembly and a rotor assembly. The stepping motor further includes a first magnetic spring sleeved and fixed on the shaft, the first magnetic spring includes a first magnetic ring in a ring shape and a second magnetic ring. Compared with the prior art, the present invention effectively strengthens the axial restraint of the motor rotor by adding non-contact magnetic springs to the shaft of the rotor. This can eliminate axial displacement. Meanwhile, since there is no physical contact between the non-contact magnetic springs and the shaft, no additional friction will be introduced. The output torque is superior to that of the existing contact-type coil springs or elastic washers, and the running noise of the motor is significantly reduced.

### CROSS-REFERENCE TO RELATED APPLICATIONS

This application is a continuation of International Application No. PCT/CN2024/103181, filed on Jul. 2, 2024, the entire content of which is incorporated herein by reference.

### TECHNICAL FIELD

The present invention relates to the technical field of electric motors, in particular to a stepping motor.

### BACKGROUND

Stepping motors have been widely applied in fields such as electric motors and generators due to their compact structure, high power density, high working efficiency, and remarkable energy-saving and consumption-reducing benefits. In recent years, the industrial field has an increasingly urgent demand for equipment that directly drivings loads using stepping motors. The extensive application of these stepping motor direct-driving devices will generate inestimable energy-saving benefits.

During the operation of stepping motors, there may be axial displacement, which makes the motors unstable. Existing methods usually adopt coil springs or elastic washers to alleviate the axial displacement of the motors. However, the additional friction introduced by such contact-type coil springs or elastic washers will cause the motors to generate significant noise during operation, and the effect of preventing axial displacement is not satisfactory.

Therefore, it is necessary to provide a new type of stepping motor to solve the above-mentioned technical problems.

### SUMMARY

The present invention provides a stepping motor, aiming to eliminate the axial displacement that occurs during the operation of the stepping motor and reduce the additional friction and the operating noise of the motor introduced by using traditional contact-type coil springs or elastic washers.

In order to achieve the above object, the present invention discloses a stepping motor.

A stepping motor includes a first cover plate, a second cover plate, a stator assembly and a rotor assembly. The stator assembly and the rotor assembly are sandwiched between the first cover plate and the second cover plate, the rotor assembly is inserted between the first cover plate and the second cover plate and forms a rotational connection with the first cover plate and the second cover plate, and the stator assembly is spaced around the rotor assembly. The rotor assembly includes a shaft, a magnetic conductive ring sleeved and fixed on the shaft and a magnetic steel sleeved and fixed on the magnetic conductive ring. The stator assembly includes a first driving unit and a second driving unit. The first driving unit and the second driving unit are distributed in an abutting manner along an axial direction of the shaft, the first driving unit is abutted and fixed on one side of the first cover plate facing the second cover plate, the second driving unit is abutted and fixed on one side of the second cover plate facing the first cover plate, and the first driving unit and the second driving unit are spaced around the magnetic steel along a radial direction of the shaft; the stepping motor further includes a first magnetic spring sleeved and fixed on the shaft, the first magnetic spring includes a first magnetic ring in a ring shape and a second magnetic ring arranged opposite and spaced from the first magnetic ring, and inner diameters of the first magnetic ring and the second magnetic ring are greater than a diameter of the shaft; the first magnetic ring is fixed on the first cover plate and forms a rotational connection with the shaft, the second magnetic ring is fixed on the magnetic conductive ring and rotates together with the shaft, and the first magnetic ring and the second magnetic ring are magnetized along a thickness direction and the magnetization directions are opposite.

Preferably, the stepping motor further includes a second magnetic spring sleeved and fixed on the shaft, the second magnetic spring includes a third magnetic ring in a ring shape and a fourth magnetic ring arranged opposite and spaced from the third magnetic ring, and inner diameters of the third magnetic ring and the fourth magnetic ring are greater than the diameter of the shaft, the third magnetic ring is fixed on the second cover plate and forms a rotational connection with the shaft, the fourth magnetic ring is fixed on the magnetic conductive ring and rotates together with the shaft, and the third magnetic ring and the fourth magnetic ring are magnetized along a thickness direction and the magnetization directions are opposite.

Preferably, the magnetic steel includes a first magnetic steel and a second magnetic steel, the first magnetic steel and the second magnetic steel are spaced along the axial direction of the shaft, and the first driving unit is spaced around the first magnetic steel along the radial direction of the shaft, and the second driving unit is spaced around the second magnetic steel along the radial direction of the shaft.

Preferably, the first cover plate and the second cover plate are respectively provided with a first through hole and a second through hole penetrating along the axial direction of the shaft, and the first magnetic ring and the third magnetic ring are respectively embedded and fixed inside the first through hole and the second through hole.

Preferably, the magnetic conductive ring includes a first magnetic conductive ring and a second magnetic conductive ring, the first magnetic conductive ring and the second magnetic conductive ring are spaced along the axial direction of the shaft, the first magnetic steel is sleeved and fixed on the first magnetic conductive ring, the second magnetic steel is sleeved and fixed on the second magnetic conductive ring, the second magnetic ring is fixedly embedded on one side of the first magnetic conductive ring adjacent to the first cover plate, and the fourth magnetic ring is fixedly embedded on one side of the second magnetic conductive ring adjacent to the second cover plate.

Preferably, the stepping motor further includes a first bearing and a second bearing sleeved on the shaft and forming a rotational connection with the shaft, the first bearing includes a first bearing body fixed inside the first through hole, a second bearing body extending from the first bearing body in a direction away from the first cover plate in parallel with the axial direction of the shaft and a first limiting ring extending from an outer peripheral side of the second bearing body in a direction away from the shaft along a radial direction, the first bearing body is abutted and fixed on one side of the first magnetic ring away from the first magnetic steel, and the first limiting ring is abutted and fixed on one side of the first cover plate away from the first magnetic steel; the second bearing includes a third bearing body fixed inside the second through hole, a fourth bearing body extending from the third bearing body in a direction away from the second cover plate in parallel with the axial direction of the shaft and a second limiting ring extending from an outer peripheral side of the fourth bearing body in a direction away from the shaft along a radial direction, the third bearing body is abutted and fixed on one side of the third magnetic ring away from the second magnetic steel, and the second limiting ring is abutted and fixed on one side of the second cover plate away from the second magnetic steel.

Preferably, the first cover plate forms a rotational connection with the shaft through the first bearing body, the second bearing body and the first magnetic ring, and the second cover plate forms a rotational connection with the shaft through the third bearing body, the fourth bearing body and the third magnetic ring.

Preferably, the first driving unit includes a first cylindrical skeleton, a first coil and a first stator magnetic ring, the first stator magnetic ring is spaced around the first magnetic steel along the radial direction of the shaft and is abutted and fixed on one side of the first cover plate facing the second cover plate, the first stator magnetic ring includes a first claw-shaped half body and a second claw-shaped half body, the first claw-shaped half body and the second claw-shaped half body are oppositely buckled to form a cylindrical first accommodating space, the first cylindrical skeleton is fixed inside the first accommodating space, and the first coil is wound around an outer periphery of the first cylindrical skeleton; the second driving unit includes a second cylindrical skeleton, a second coil and a second stator magnetic ring, the second stator magnetic ring is spaced around the second magnetic steel along the radial direction of the shaft and is abutted and fixed on one side of the second cover plate facing the first cover plate, the second stator magnetic ring includes a third claw-shaped half body and a fourth claw-shaped half body, the third claw-shaped half body and the fourth claw-shaped half body are oppositely buckled to form a cylindrical second accommodating space, the second cylindrical skeleton is fixed inside the second accommodating space, and the second coil is wound around an outer periphery of the second cylindrical skeleton.

Preferably, the first claw-shaped half body includes a sidewall, a top wall extending from one side of the sidewall adjacent to the first cover plate along the radial direction of the shaft toward the shaft and a plurality of first claw-poles extending from one side of the top wall adjacent to the shaft along the axial direction of the shaft toward a direction away from the top wall, and the second claw-shaped half body includes a base and a plurality of second claw-poles extending from one side of the base adjacent to the shaft along the axial direction of the shaft toward a direction away from the base.

Preferably, the plurality of first claw-poles and the plurality of second claw-poles are arranged in an interleaved and interlocked manner.

Compared with the prior art, the present invention effectively strengthens the axial restraint of the motor rotor by adding non-contact magnetic springs to the shaft of the rotor. This can eliminate axial displacement. Meanwhile, since there is no physical contact between the non-contact magnetic springs and the shaft, no additional friction will be introduced. The output torque is superior to that of the existing contact-type coil springs or elastic washers, and the running noise of the motor is significantly reduced.

### BRIEF DESCRIPTION OF THE DRAWINGS

In order to explain the technical solutions of the embodiments of the present invention more clearly, the following will briefly introduce the accompanying drawings used in the embodiments. Apparently, the drawings in the following description are only some embodiments of the present invention. Those of ordinary skill in the art can obtain other drawings based on these drawings without creative work.

FIG. 1 is a schematic diagram of a 3D structure of a stepping motor according to an embodiment of the present invention;

FIG. 2 is a cross-sectional view cut along A-A line of FIG. 1;

FIG. 3 is a schematic exploded view of the 3D structure of the stepping motor according to the embodiment of the present invention; and

FIG. 4 is a schematic exploded view of the 3D structure of a second stator magnetic ring of the stepping motor according to the embodiment of the present invention.

### DETAILED DESCRIPTION OF THE EMBODIMENTS

The accompanying drawings in the embodiment of the present invention are combined. The technical scheme in the embodiment of the present invention is clearly and completely described, Obviously, the described embodiment is only a part of the embodiment of the present invention, but not all embodiments are based on the embodiment of the present invention, and all other embodiments obtained by ordinary technicians in the field on the premise of not doing creative work belong to the protection range of the present invention.

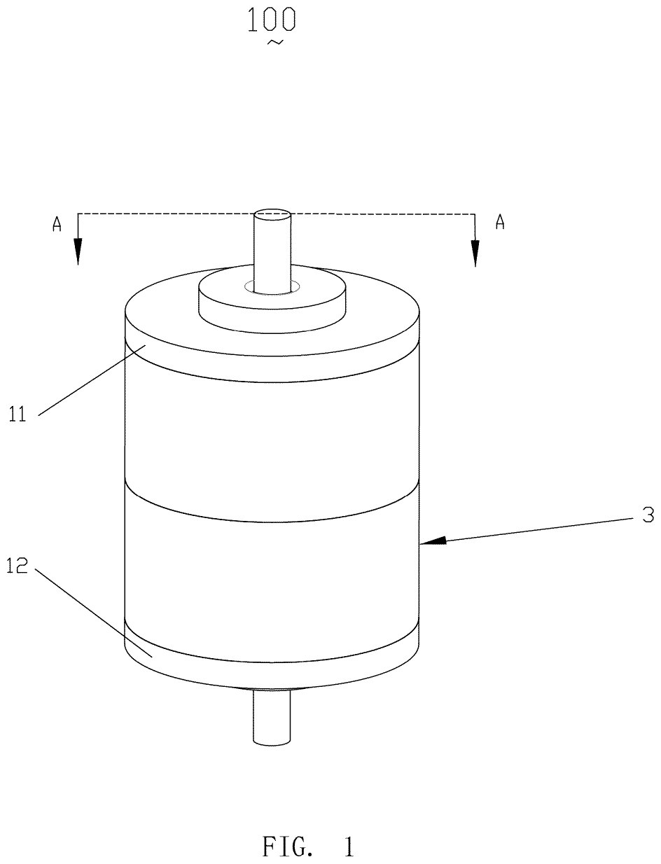

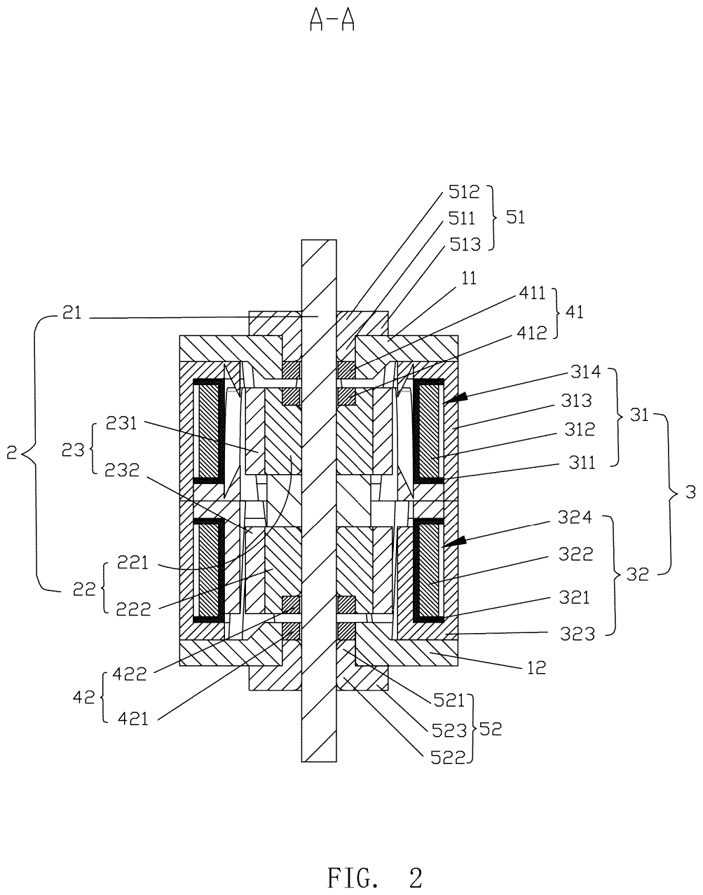

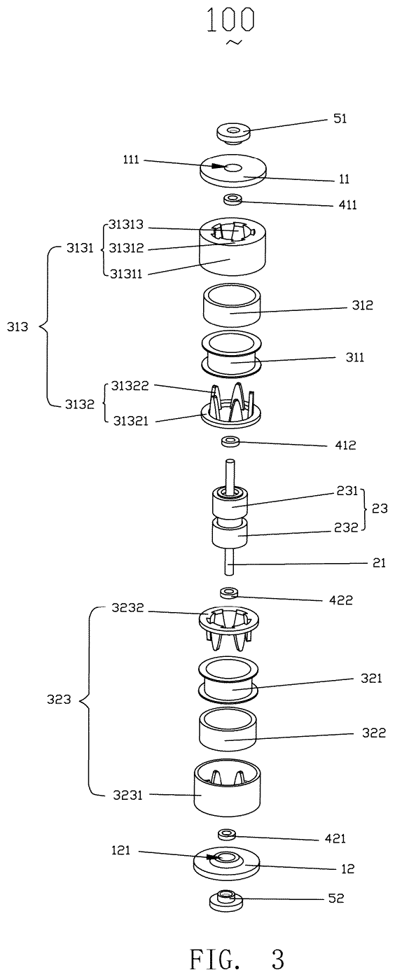

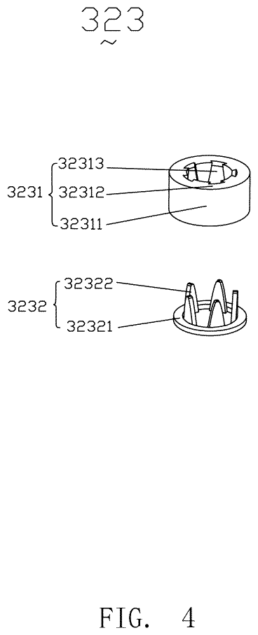

Referring to FIG. 1 to FIG. 4, an embodiment of the present invention provides a stepping motor 100. The stepping motor 100 includes a first cover plate 11, a second cover plate 12, a stator assembly 3 and a rotor assembly 2 sandwiched between the first cover plate 11 and the second cover plate 12. The rotor assembly 2 is inserted between the first cover plate 11 and the second cover plate 12 and forms a rotational connection with the first cover plate 11 and the second cover plate 12, and the stator assembly is spaced around the rotor assembly.

The rotor assembly 2 includes a shaft 21, a magnetic conductive ring 22 sleeved and fixed on the shaft 21 and a magnetic steel 23 sleeved and fixed on the magnetic conductive ring 22. The magnetic steel 23 includes a first magnetic steel 231 and a second magnetic steel 232, and the first magnetic steel 231 and the second magnetic steel 232 are spaced along an axial direction of the shaft 21.

The stator assembly 3 includes a first driving unit 31 and a second driving unit 32 which are distributed in an abutting manner along the axial direction of the shaft 21, the first driving unit 31, the second driving unit 32 and the rotor assembly 2 are spaced along a radial direction of the shaft 21, the first driving unit 31 is abutted and fixed on one side of the first cover plate 11 facing the second cover plate 12, and the second driving unit 32 is abutted and fixed on one side of the second cover plate 12 facing the first cover plate 11. The first driving unit 31 and the second driving unit 32 are spaced around the magnetic steel 23 along the radial direction of the shaft 21, the first driving unit 31 is spaced around the first magnetic steel 231 along the radial direction of the shaft 21, and the second driving unit 32 is spaced around the second magnetic steel 232 along the radial direction of the shaft 21.

The stepping motor 100 further includes a first magnetic spring 41 sleeved and fixed on the shaft 21, the first magnetic spring 41 includes a first magnetic ring 411 in a ring shape and a second magnetic ring 412 arranged opposite and spaced from the first magnetic ring 411, and inner diameters of the first magnetic ring 411 and the second magnetic ring 412 are greater than a diameter of the shaft 21.

The first magnetic ring 411 is fixed on the first cover plate 11 and forms a rotational connection with the shaft 21, the second magnetic ring 412 is fixed on the magnetic conductive ring 22 and rotates together with the shaft 21, and the first magnetic ring 411 and the second magnetic ring 412 are magnetized along a thickness direction and the magnetization directions are opposite.

In this embodiment, the stepping motor 100 further includes a second magnetic spring 42 sleeved and fixed on the shaft 21, the second magnetic spring 42 includes a third magnetic ring 421 in a ring shape and a fourth magnetic ring 422 arranged opposite and spaced from the third magnetic ring 421, and inner diameters of the third magnetic ring 421 and the fourth magnetic ring 422 are greater than the diameter of the shaft 21, the third magnetic ring 421 is fixed on the second cover plate 12 and forms a rotational connection with the shaft 21, the fourth magnetic ring 422 is fixed on the magnetic conductive ring 22 and rotates together with the shaft 21, and the third magnetic ring 421 and the fourth magnetic ring 422 are magnetized along a thickness direction and the magnetization directions are opposite.

In this embodiment, the first cover plate 11 and the second cover plate 12 are respectively provided with a first through hole 111 and a second through hole 121 penetrating along the axial direction of the shaft 21, and the first magnetic ring 411 and the third magnetic ring 421 are respectively embedded and fixed inside the first through hole 111 and the second through hole 121.

In this embodiment, the magnetic conductive ring 22 includes a first magnetic conductive ring 221 and a second magnetic conductive ring 222, the first magnetic conductive ring 221 and the second magnetic conductive ring 222 are spaced along the axial direction of the shaft, the first magnetic steel 231 is sleeved and fixed on the first magnetic conductive ring 221, the second magnetic steel 232 is sleeved and fixed on the second magnetic conductive ring 222, the second magnetic ring 412 is fixedly embedded on one side of the first magnetic conductive ring 221 adjacent to the first cover plate 11, and the fourth magnetic ring 422 is fixedly embedded on one side of the second magnetic conductive ring 222 adjacent to the second cover plate 12.

In this embodiment, the stepping motor 100 further includes a first bearing 51 and a second bearing 52 sleeved on the shaft 21 and forming a rotational connection with the shaft 21, the first bearing 51 includes a first bearing body 511 fixed inside the first through hole 111, a second bearing body 512 extending from the first bearing body 511 in a direction away from the first cover plate 11 in parallel with the axial direction of the shaft 21 and a first limiting ring 513 extending from an outer peripheral side of the second bearing body 512 in a direction away from the shaft 21 along a radial direction, the first bearing body 511 is abutted and fixed on one side of the first magnetic ring 411 away from the first magnetic steel 231, and the first limiting ring 513 is abutted and fixed on one side of the first cover plate 11 away from the first magnetic steel 231.

The second bearing 52 includes a third bearing body 521 fixed inside the second through hole 121, a fourth bearing body 522 extending from the third bearing body 521 in a direction away from the second cover plate 12 in parallel with the axial direction of the shaft 21 and a second limiting ring 523 extending from an outer peripheral side of the fourth bearing body 522 in a direction away from the shaft 21 along a radial direction, the third bearing body 521 is abutted and fixed on one side of the third magnetic ring 421 away from the second magnetic steel 232, and the second limiting ring 523 is abutted and fixed on one side of the second cover plate 12 away from the second magnetic steel 232.

In this embodiment, both ends of the shaft 21 respectively penetrate through the first cover plate 11 and the second cover plate 12, and respectively form rotational connections with the first cover plate 11 and the second cover plate 12.

In this embodiment, the first cover plate 11 forms a rotational connection with the shaft 21 through the first bearing body 511, the second bearing body 512 and the first magnetic ring 411, and the second cover plate 12 forms a rotational connection with the shaft 21 through the third bearing body 521, the fourth bearing body 522 and the third magnetic ring 422.

In this embodiment, the first driving unit 31 includes a first cylindrical skeleton 311, a first coil 312 and a first stator magnetic ring 313, the first stator magnetic ring 313 is spaced around the first magnetic steel 231 along the radial direction of the shaft 21 and is abutted and fixed on one side of the first cover plate 11 facing the second cover plate 12, the first stator magnetic ring 313 includes a first claw-shaped half body 3131 and a second claw-shaped half body 3132, the first claw-shaped half body 3131 and the second claw-shaped half body 3132 are oppositely buckled to form a cylindrical first accommodating space 314, the first cylindrical skeleton 311 is fixed inside the first accommodating space 314, and the first coil 312 is wound around an outer periphery of the first cylindrical skeleton 311.

In this embodiment, the second driving unit 32 includes a second cylindrical skeleton 321, a second coil 322 and a second stator magnetic ring 323, the second stator magnetic ring 323 is spaced around the second magnetic steel 232 along the radial direction of the shaft 21 and is abutted and fixed on one side of the second cover plate 12 facing the first cover plate 11, the second stator magnetic ring 323 includes a third claw-shaped half body 3231 and a fourth claw-shaped half body 3232, the third claw-shaped half body 3231 and the fourth claw-shaped half body 3232 are oppositely buckled to form a cylindrical second accommodating space 324, the second cylindrical skeleton 321 is fixed inside the second accommodating space 324, and the second coil 322 is wound around an outer periphery of the second cylindrical skeleton 321.

In this embodiment, the first claw-shaped half body 3131 includes a sidewall 31311, a top wall 31312 extending from one side of the sidewall 31311 adjacent to the first cover plate 11 along the radial direction of the shaft 21 toward the shaft 21 and a plurality of first claw-poles 31313 extending from one side of the top wall 31312 adjacent to the shaft 21 along the axial direction of the shaft 21 toward a direction away from the top wall 31312, and the second claw-shaped half body 3132 includes a base 31321 and a plurality of second claw-poles 31322 extending from one side of the base 31321 adjacent to the shaft 21 along the axial direction of the shaft 21 toward a direction away from the base 31321. The plurality of first claw-poles 31313 and the plurality of second claw-poles 31322 are arranged in an interleaved and interlocked manner, stabilizing the magnetic field.

In this embodiment, the third claw-shaped half body 3231 includes a second sidewall 32311, a second top wall 32312 extending from one side of the second sidewall 32311 adjacent to the second cover plate 12 along the radial direction of the shaft 21 toward the shaft 21 and a plurality of third claw-poles 32313 extending from one side of the second top wall 32312 adjacent to the shaft 21 along the axial direction of the shaft 21 toward a direction away from the second top wall 32312, and the fourth claw-shaped half body 3232 includes a second base 32321 and a plurality of fourth claw-poles 32322 extending from one side of the second base 32321 adjacent to the shaft 21 along the axial direction of the shaft 21 toward a direction away from the second base 32321. The plurality of third claw-poles 32313 and the plurality of fourth claw-poles 32322 are arranged in an interleaved and interlocked manner, stabilizing the magnetic field.

The top wall 31312 is abutted against the first cover plate 11, the second top wall 32312 is abutted against the second cover plate 12, and the base 31321 is abutted against the second base 32321.

Compared with the prior art, the present invention effectively strengthens the axial restraint of the motor rotor by adding non-contact magnetic springs to the shaft of the rotor. This can eliminate axial displacement. Meanwhile, since there is no physical contact between the non-contact magnetic springs and the shaft, no additional friction will be introduced. The output torque is superior to that of the existing contact-type coil springs or elastic washers, and the running noise of the motor is significantly reduced.

The above is only the preferred embodiments of the present invention. It should be noted that those of ordinary skill in the art can further make improvements without departing from the concept of the present invention. These improvements shall all fall within the protection scope of the present invention.

What is claimed is:

1. A stepping motor comprising:
a first cover plate;
a second cover plate;
a stator assembly; and
a rotor assembly,
wherein the stator assembly and the rotor assembly are sandwiched between the first cover plate and the second cover plate, the rotor assembly is inserted between the first cover plate and the second cover plate and forms a rotational connection with the first cover plate and the second cover plate, and the stator assembly is spaced around the rotor assembly;
the rotor assembly comprising:
a shaft;
a magnetic conductive ring sleeved and fixed on the shaft; and
a magnetic steel sleeved and fixed on the magnetic conductive ring,
the stator assembly comprising:
a first driving unit; and
a second driving unit,
wherein the first driving unit and the second driving unit are distributed in an abutting manner along an axial direction of the shaft, the first driving unit is abutted and fixed on one side of the first cover plate facing the second cover plate, the second driving unit is abutted and fixed on one side of the second cover plate facing the first cover plate, and the first driving unit and the second driving unit are spaced around the magnetic steel along a radial direction of the shaft;
the stepping motor further comprises a first magnetic spring sleeved and fixed on the shaft, the first magnetic spring comprises a first magnetic ring in a ring shape and a second magnetic ring in a ring shape arranged opposite and spaced from the first magnetic ring, and inner diameters of the first magnetic ring and the second magnetic ring are greater than a diameter of the shaft;
the first magnetic ring is fixed on the first cover plate and forms a rotational connection with the shaft, the second magnetic ring is fixed on the magnetic conductive ring and rotates together with the shaft, and the first magnetic ring and the second magnetic ring are magnetized along a thickness direction and the magnetization directions are opposite.

2. The stepping motor according to claim 1, wherein the stepping motor further comprises a second magnetic spring sleeved and fixed on the shaft, the second magnetic spring comprises a third magnetic ring in a ring shape and a fourth magnetic ring in a ring shape arranged opposite and spaced from the third magnetic ring, and inner diameters of the third magnetic ring and the fourth magnetic ring are greater than the diameter of the shaft, the third magnetic ring is fixed on the second cover plate and forms a rotational connection with the shaft, the fourth magnetic ring is fixed on the magnetic conductive ring and rotates together with the shaft, and the third magnetic ring and the fourth magnetic ring are magnetized along a thickness direction and the magnetization directions are opposite.

3. The stepping motor according to claim 2, wherein the magnetic steel comprises a first magnetic steel and a second magnetic steel, the first magnetic steel and the second magnetic steel are spaced along the axial direction of the shaft, and the first driving unit is spaced around the first magnetic steel along the radial direction of the shaft, and the second driving unit is spaced around the second magnetic steel along the radial direction of the shaft.

4. The stepping motor according to claim 3, wherein the first cover plate and the second cover plate are respectively provided with a first through hole and a second through hole penetrating along the axial direction of the shaft, and the first magnetic ring and the third magnetic ring are respectively embedded and fixed inside the first through hole and the second through hole.

5. The stepping motor according to claim 4, wherein the magnetic conductive ring comprises a first magnetic conductive ring and a second magnetic conductive ring, the first magnetic conductive ring and the second magnetic conductive ring are spaced along the axial direction of the shaft, the first magnetic steel is sleeved and fixed on the first magnetic conductive ring, the second magnetic steel is sleeved and fixed on the second magnetic conductive ring, the second magnetic ring is fixedly embedded on one side of the first magnetic conductive ring adjacent to the first cover plate, and the fourth magnetic ring is fixedly embedded on one side of the second magnetic conductive ring adjacent to the second cover plate.

6. The stepping motor according to claim 5, wherein the stepping motor further comprises a first bearing and a second bearing sleeved on the shaft and forming a rotational connection with the shaft, the first bearing comprises a first bearing body fixed inside the first through hole, a second bearing body extending from the first bearing body in a direction away from the first cover plate in parallel with the axial direction of the shaft and a first limiting ring extending from an outer peripheral side of the second bearing body in a direction away from the shaft along a radial direction, the first bearing body is abutted and fixed on one side of the first magnetic ring away from the first magnetic steel, and the first limiting ring is abutted and fixed on one side of the first cover plate away from the first magnetic steel;
the second bearing comprises a third bearing body fixed inside the second through hole, a fourth bearing body extending from the third bearing body in a direction away from the second cover plate in parallel with the axial direction of the shaft and a second limiting ring extending from an outer peripheral side of the fourth bearing body in a direction away from the shaft along a radial direction, the third bearing body is abutted and fixed on one side of the third magnetic ring away from the second magnetic steel, and the second limiting ring is abutted and fixed on one side of the second cover plate away from the second magnetic steel.

7. The stepping motor according to claim 6, wherein the first cover plate forms a rotational connection with the shaft through the first bearing body, the second bearing body and the first magnetic ring, and the second cover plate forms a rotational connection with the shaft through the third bearing body, the fourth bearing body and the third magnetic ring.

8. The stepping motor according to claim 1, wherein the first driving unit comprises a first cylindrical skeleton, a first coil and a first stator magnetic ring, the first stator magnetic ring is spaced around the first magnetic steel along the radial direction of the shaft and is abutted and fixed on one side of the first cover plate facing the second cover plate, the first stator magnetic ring comprises a first claw-shaped half body and a second claw-shaped half body, the first claw-shaped half body and the second claw-shaped half body are oppositely buckled to form a cylindrical first accommodating space, the first cylindrical skeleton is fixed inside the first accommodating space, and the first coil is wound around an outer periphery of the first cylindrical skeleton;
the second driving unit comprises a second cylindrical skeleton, a second coil and a second stator magnetic ring, the second stator magnetic ring is spaced around the second magnetic steel along the radial direction of the shaft and is abutted and fixed on one side of the second cover plate facing the first cover plate, the second stator magnetic ring comprises a third claw-shaped half body and a fourth claw-shaped half body, the third claw-shaped half body and the fourth claw-shaped half body are oppositely buckled to form a cylindrical second accommodating space, the second cylindrical skeleton is fixed inside the second accommodating space, and the second coil is wound around an outer periphery of the second cylindrical skeleton.

9. The stepping motor according to claim 8, wherein the first claw-shaped half body comprises a sidewall, a top wall extending from one side of the sidewall adjacent to the first cover plate along the radial direction of the shaft toward the shaft and a plurality of first claw-poles extending from one side of the top wall adjacent to the shaft along the axial direction of the shaft toward a direction away from the top wall, and the second claw-shaped half body comprises a base and a plurality of second claw-poles extending from one side of the base adjacent to the shaft along the axial direction of the shaft toward a direction away from the base.

10. The stepping motor according to claim 9, wherein the plurality of first claw-poles and the plurality of second claw-poles are arranged in an interleaved and interlocked manner.
